(19) United States
(12) Patent Application Publication
(10) Pub. No.: US 2010/0064898 A1
(43) Pub. Date: Mar. 18, 2010

(54) CUP FOR PREPARATION OF A LIQUID PRODUCT, AND COUNTERPRESSURE ELEMENT THEREFOR

(75) Inventors: Cornelis Margaretha Theodorus Maria Bongers, Helmond (NL); Wiebe Nicolaas Van Druten, Zeewolde (NL)

Correspondence Address: SUGHRUE MION, PLLC, 2100 PENNSYLVANIA AVENUE, N.W., SUITE 800, WASHINGTON, DC, 20037, US

(73) Assignee: Friesland Brands B.V, Meppel (NL)

(21) Appl. No.: 12/514,709

(22) PCT Filed: Dec. 4, 2007
(86) PCT No.: PCT/NL2007/050621

§ 371 Date: Jul. 31, 2009

(30) Foreign Application Priority Data
Dec. 22, 2006 (NL) 2000402

(51) Int. Cl. A47J 31/06

(52) U.S. Cl. 99/295

(57) ABSTRACT

A cup for preparing a liquid product, having an outlet opening for discharging the prepared beverage or dish, which outlet opening is sealed with a seal prior to use, and having a space around the outlet opening. The seal includes a piercable seal. The outlet opening has a conically shaped outer side which is equipped so that in operation it works together with a passive counterpressure element to pierce the seal from the inside of the cup in order to clear the outlet opening

### FIELD OF THE INVENTION

The present invention relates to a cup for preparation of a liquid product, comprising an outlet opening for discharging the prepared beverage or dish, which outlet opening is sealed with a seal prior to use, and comprising a space situated around the outlet opening.

### PRIOR ART

Cartridges for use in the preparation of hot drinks based on a liquid concentrate are known, inter alia from WO-A-01/58786, EP-A-0 449 533, EP-A-1 101 430, WO-A1-03/073896, WO-A1-03/053200, WO-A1-02/19875, U.S. Pat. No. 6,130,990, U.S. Pat. No. 4,886,674, EP-A-1 440 907 and EP-A-1 440 908.

European patent publication EP-A-0 389 141 discloses a beverage package with a preparation substance which is provided with a sealed outlet opening. The package is provided with a hollow space in which a foil which originally seals the outlet opening is folded away after being partially cut through. This package requires a cutting machine for partially cutting through the foil, which can constitute a hazard for users. Furthermore the hollow space needs to be sufficiently deep to enable sufficient foil to be folded away in order to clear the outlet opening fully.

European patent publication EP-A-0 334 572 discloses a method for preparing a beverage using a package with a beverage ingredient. In this case a seal of the package is first pierced with a tool and a seal flap which has been formed is then folded away. The tool is not part of the package, but is present outside the package and is equipped so as actively to cut through the seal from outside the package.

American patent publication U.S. Pat. No. 3,995,773 discloses a flexible container for a liquid, having a rigid tubular member which permits outflow of the liquid. Before use, the tubular member is sealed by a membrane which is opened from the outside by a cutting element for use.

American patent publication U.S. Pat. No. 4,216,885 discloses a disposable package for a liquid which is sealed by a rupturable membrane. An externally placed receiving element for the package comprises, inter alia, a tubular channel with a slanting cutting edge. Said cutting edge can cut through the membrane of the package, after which the liquid can flow out through the tubular channel.

Other publications, such as BE-A-534496A1, U.S. Pat. No. 2,698,113, U.S. Pat. No. 4,376,496 and U.S. Pat. No. 4,426,019, also disclose the use of tools for removing sealing foil from a flow path.

WO-A-01/58786 and EP-A-0 449 533 disclose a cartridge in which hot water is conveyed through a pointed inflow opening on the underside of the cartridge by way of a ‘ring line’ containing distribution openings, and also by way of said distribution openings through a compartment containing a concentrate, the water diluting the concentrate to a beverage by means of turbulence, which beverage is then conveyed by means of a siphon to an outflow opening on the underside of the cartridge.

EP-A-1 101 430 discloses a stepped cartridge in which, inter alia, provisions are included for using a liquid concentrate (paras [0034] and [0035]). For use of this cartridge the wall of the cartridge is pierced, after which hot water is conveyed through the concentrate by way of the inflow opening(s) thus created, thereby diluting the concentrate to a beverage, said beverage leaving the cartridge by way of a likewise pierced outflow opening.

WO-A1-03/073896 discloses a cartridge in which the underside of the cartridge is provided with perforations and is covered with a foil, which foil has to be removed before use. This cartridge also is suitable for a liquid concentrate (p. 14, lines 3-8 and Claim 18), hot water being conveyed through the concentrate from an inflow opening on the upper side, thereby diluting the concentrate to form a beverage, said beverage leaving the cartridge by way of the preformed perforations on the underside.

WO-A1-03/053200 and WO-A1-02/19875 disclose cartridges made of a flexible material, which cartridges are suitable for, inter alia, a liquid concentrate (WO-A1-03/053200, p. 5, lines 19-21; WO-A1-02/19875, p. 19, lines 4-6) for use in a water heater, the cartridge being clamped in a cavity designed for it and being pierced by a hollow needle, after which the water is conveyed through the concentrate to the outflow opening.

U.S. Pat. No. 6,130,990 discloses a water heater which is suitable for preparing a beverage based on concentrate in a cartridge (col. 5, lines 54-67; col. 7, lines 58-61; col. 9, line 66—col. 10, line 6).

U.S. Pat. No. 4,886,674 discloses a cartridge made of a flexible material, which cartridge is suitable for, inter alia, a liquid concentrate, the water supply being conveyed by way of a connection point through the concentrate to an outflow opening, which outflow opening is created by a weakened sealing seam, which sealing seam is opened by the working pressure of the machine.

European patent applications EP-A-1 440 907 and EP-A-1 440 908 disclose a cartridge for use in the preparation of beverages. This cartridge is dome-shaped and is sealed on the underside by means of a foil, and on the foil side is provided with both an inlet opening (on the edge) and an outlet opening (in the middle). Water (hot water) is conveyed by way of a pointed inflow opening on the underside of the cartridge and by way of a ‘ring line’ containing distribution openings against the sealing foil, and also by way of said distribution openings through a compartment. The compartment contains a concentrate, and the water dilutes the concentrate to a beverage by means of turbulence, which beverage is then conveyed by way of a siphon to an outflow opening on the underside of the cartridge. Special measures are also in place in the cartridge to ensure that the water runs evenly from the inlet opening in a radially inwardly directed manner through the interior space of the cartridge.

In a further embodiment EP-A-1 440 907 discloses a method for controlling the mixing of the water with the concentrate by means of provisions which delay the mixing of the concentrate with the water. In this case this provision is in the form of a sort of plate, the concentrate being added to the flow path of the water in a delayed manner through the holes on the underside of the plate.

None of the cartridges discussed above can be used in a water heater suitable for extraction pads made of filter material, so that it is necessary to use a preparation machine specially designed for these respective cartridge types. In particular, the connection of the inflow point to the cartridges means that water heaters that are suitable for extraction pads made of filter material are unsuitable for the abovementioned cartridges.

It is pointed out that a cup such as that referred to in the preamble above is disclosed in non pre-published application PCT/NL2006/050144.

### SUMMARY OF THE INVENTION

The aim of the present invention is to provide an improved cup or cartridge for the preparation in particular of hot products such as a chocolate beverage, with an efficient and reliable seal of the outlet opening, both during transport and storage and during use.

To this end, according to the present invention, a cup of the type mentioned in the preamble is provided, in which the seal comprises a piercable seal and the outlet opening has a conically shaped outer side which is arranged so that in operation it works together with a counterpressure element to pierce the seal from inside the cup in order to clear the outlet opening. Owing to the fact that the seal is pierced from inside the cup, the counterpressure element can be designed so as to be entirely passive and free from hazardous elements. The conically shaped outer side of the outlet opening ensures that the seal is first opened at the position of the outlet opening.

In one embodiment the seal is provided with weakened parts, so that said seal will break open in a predictable manner under pressure from the conically shaped outer side of the outlet opening. The weakened parts comprise, for example, machined lines running in the radial direction from the position where the seal seals the outlet opening prior to use.

In a further embodiment the space lying round the outlet opening is bounded by a wall, and the space has a dimension in the direction of an axis of symmetry of the cup, i.e. a height, which is less than half the distance between the wall and a furthest removed outer side of the outlet opening. Owing to the fact that the height can remain limited, while the outlet opening can still be reliably fully cleared during operation, more space is available for the internal mechanism of the cup, for example in the form of a static mixer.

In one embodiment the cup works together with a passive counterpressure element, which is provided with an edge of such shape that said edge cannot pierce the seal. In this way the counterpressure element can remain inactive, and need only exert a passive counterpressure upon the seal at the position of the space, since the seal is opened by elements in the cup itself.

An outer side of the outlet opening is provided with ribs projecting radially from the outflow opening. These ribs can be in the form of cutting elements, for example with a sharp edge facing the seal, and furthermore can improve the opening of the seal from the inside.

In a further embodiment the seal is a composite foil consisting of a plastic film (for example, polypropylene) and an aluminium film. This composition is extremely well suited for sealing a cup containing a preparation substance such as a chocolate concentrate effectively during transport and storage, while said seal is also easy to open in the manner described earlier.

In yet a further embodiment the plastic film comprises a material which is softer than the material of the cup. The result is that the outlet opening can be sealed reliably, so that contamination cannot enter the cup from the outside, and also so that preparation substance cannot be lost from the cup.

In one embodiment of the cup the outlet opening is provided with a rough internal surface. This results in better frothing, for example with additional longitudinal grooves around an inner circumference of the outlet opening. Such an improvement in frothing can also be achieved by a further embodiment in which the outlet opening is provided with an enlarged cross-sectional surface. In other words, the actual cross-sectional surface of the outlet opening is greater than a circumference of a comparable circular cross-sectional surface.

The present invention also relates to a counterpressure element for use with a cup according to one of the embodiments of the present invention, comprising a rounded edge for placing the seal of the cup under tension. The rounded edge means that the counterpressure element cannot damage or cut through the seal, so that the seal can actually be opened only from the inside of the cup.

In a further aspect the present invention relates to the use of a cup according to one of the present embodiments in a preparation machine which is provided with an accommodation space for accommodating the cup, the preparation machine being equipped with a passive element (counterpressure element) which exerts counterpressure during the placing of the cup, so that means which form part of the cup open the seal of the cup, and for guiding a liquid (for example heated water) through the cup by way of the perforated covering layer of the cup to the outlet opening.

### BRIEF DESCRIPTION OF THE DRAWINGS

The present invention will now be discussed in more detail on the basis of a number of exemplary embodiments, with reference to the appended drawings, in which:

FIG. 1 shows a cross-sectional view of a cup according to one embodiment of the present invention;

FIG. 2 shows a cross-sectional view in perspective of an outflow part of the cup according to FIG. 1;

FIGS. 3a and 3b show a cross-sectional view of the outflow part of the cup illustrating the functioning of the cup together with a counterpressure element;

FIG. 4 shows a combined bottom view and cross-sectional view of an embodiment of the outflow part of the cup; and

FIG. 5 shows a bottom view of a further embodiment of the cup.

### DETAILED DESCRIPTION

With the cup 10 according to the present invention it is possible to prepare hot beverages such as hot chocolate with a preparation machine (and possibly an accompanying holder for the cup). To this end, the cup (also known as a cartridge or reservoir) is filled with a concentrate, which by means of the machine is mixed with hot water and dispensed into a cup or mug. Other beverages or dishes can also be prepared on the basis of a concentrate or another preparation substance, milk products, fruit juices, sauces and desserts.

The preparation substance is a product that can be dissolved or suspended in a liquid, and can be a powder, a liquid (concentrated), a syrup, a gel or another similar type of product. If a powder is being used, said powder preferably does not contain any difficultly soluble or insoluble substances (such as certain proteins), so that good mixing with hot water in the cup is ensured. It is possible, for example in the embodiment of the cup 10 with a number of chamber parts to be described later, to use combinations of substances, even a combination of a concentrate and a powder.

The cup 10 can be used with different fillings in the same preparation machine, thus producing the possibility of preparing several types of products, such as hot and cold beverages, with one machine.

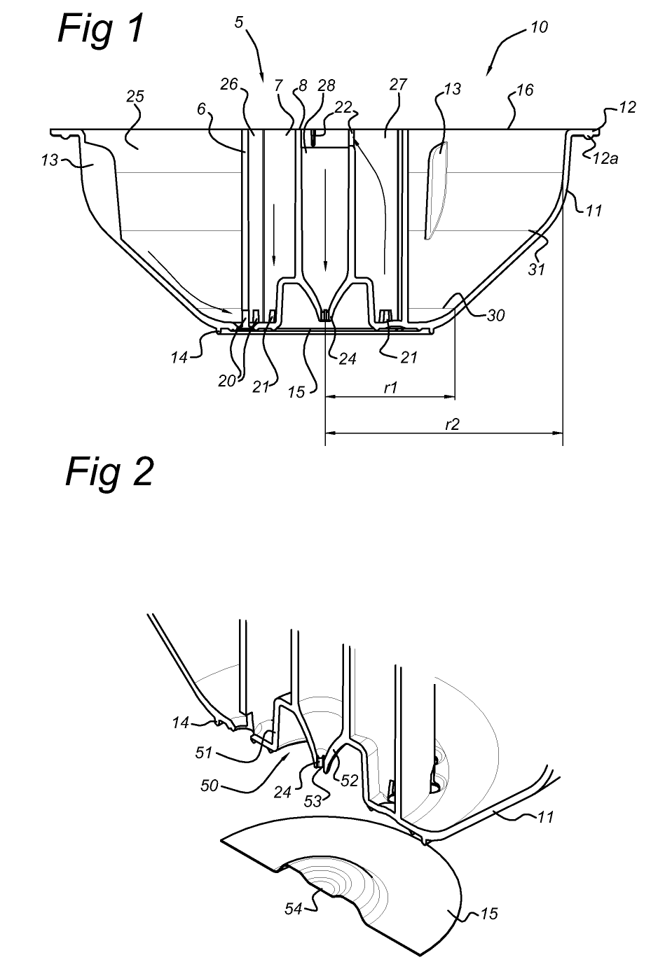

FIG. 1 shows a cross-sectional view of a cup 10 according to one embodiment of the present invention. FIG. 2 shows a cross-sectional view in perspective of the outflow part of the cup according to the embodiment of FIG. 1. The cup 10 has a shell 11 with a rim 12 on the upper side. The rim 12 can furthermore be provided with a sealing edge (not shown), which works together with a holder, for example, to provide a seal of the assembly of holder and cup 10, so that water is forced out of the machine through the cup 10. The sealing edge can also be provided as part of the holder or the preparation machine.

The bowl-shaped underside 11 is furthermore provided with an edge 14. The bowl-shaped underside 11 is sealed inside the edge 14 by a seal 15 for transport and storage. The seal 15 is, for example, a plastic seal which is suitable for use in combination with foods.

The cup 10 is sealed on the upper side by a covering layer 16. The covering layer 16 can be a composite foil and can furthermore comprise, for example, a pull-off layer.

The perforated covering layer 16 is, for example, made of a suitable plastic (for example, polypropylene), and the pull-off layer is made of another suitable material (for example, an aluminium-based foil). This means that a cup 10 filled with a preparation substance will keep well.

A static mixer 5 is present on the inside of the cup 10, which mixer can form part of the cup 10, which is produced in a single moulding step. Such a static mixer 5 contains no moving parts, which makes it simpler to produce and more reliable in operation. Using a cup with a static mixer means that a well-mixed product can still be supplied, without any finishing operation (stirring in the cup) being necessary.

By means of a cylindrical wall 6 of the static mixer 5, a first chamber part 25 is formed on the inside of the cup 10, further bounded by the inside of the shell 11 and the covering layer 16, which first chamber part can be filled (partially) with a preparation substance. The inside of the shell 11 is conically shaped in a large part of the first chamber part 25. This means that between a first radius r1 and a second radius r2 measured from the centre point of the cup 10 (indicated by lines 30 and 31 respectively on the inside of the shell 11) the inside follows a straight path. The height of the inside of the shell 11 (measured from the underside of the cup 10, for example the surface formed by edge 14) between the lines 30 and 31 runs directly proportionally to the radius from the centre of the cup 10. The part of the shell 11 between the lines 30 and 31 is a conical surface, which forms a predetermined angle with the upper side of the cup 10 (for example, indicated by the covering layer 16). The conical part of the inside of the shell 11 lies upstream of the static mixer 5.

Surprisingly, it has been found that such a shape of the inside of the shell 11 leads to the liquid that is flowing through perforations (see FIG. 5 below) in the covering layer 16 into the cup being mixed well with the preparation substance in the first chamber part 25. Experiments have shown that no residues of any kind of the preparation substance are left behind in the cup 10.

The static mixer 5 in the embodiment shown comprises at least one second chamber part 26, in which—just as in the first chamber part 25—water flows down from the upper side of the cup 10 through covering layer 16, as indicated by the arrows. The cup 10 can also be filled with a preparation substance in the second chamber part 26. Furthermore, the static mixer 5 comprises at least one riser channel 27, in which water mixed with the preparation substance coming from the first chamber part 25 and the at least one second chamber part 26 flows back up again. The static mixer 5 also comprises an outlet channel 28, which is in liquid communication with an outflow opening 24 for discharging the finished product.

The outflow opening 24 is shaped in such a way that a prepared product can flow out directly into a cup or mug, without further contact with a part of the preparation machine. This means that no residues of prepared products are left behind in the preparation machine, with the result that cross-contamination between different products prepared one after the other is prevented. It also prevents the preparation machine from being soiled.

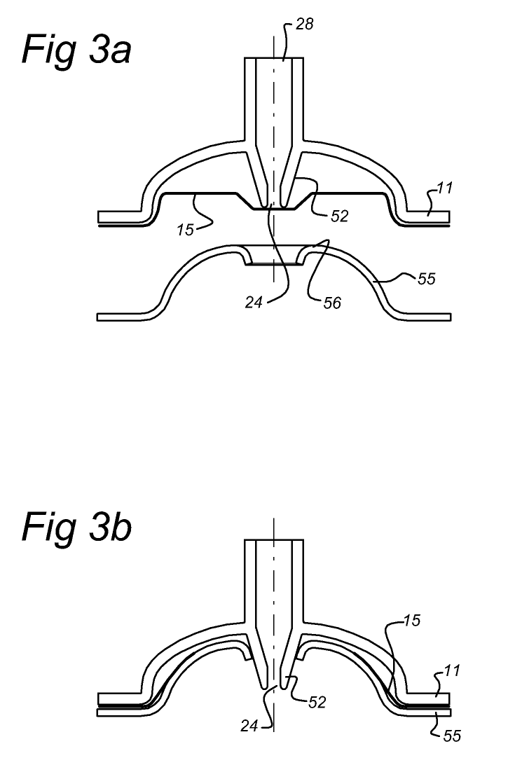

In the embodiment shown in FIG. 1 an orientation rib 13 is provided on the inside of the shell 11 for each second chamber part 26. This indicates in which area in the static mixer 5 a second chamber part 26 is located. The function of said rib is important for filling of the cup and the orientation of the covering layer 16, as is explained in greater detail with reference to FIGS. 3 and 5 below.

A number of first openings 20 are provided between the first chamber part 25 and the second chamber part 26, at the edge where the static mixer 5 connects to the shell 11. A number of second openings are also provided between each second chamber part 26 and each riser channel 27, and a third opening 22 to the outlet channel 28 is provided for each riser channel. On the underside the second chamber parts 26 and riser channels 27 are sealed by the material of the shell 11. On the upper side the second chamber parts 26, riser channels 27 and outlet channel 28 are sealed by the covering layer 16.

The structure of the cup 10 with the abovementioned elements means that during use of the cup 10 a flow such as that indicated by the arrows inside the cup occurs in the cup 10. The combination of the elements ensures optimum flow and turbulence within the cup 10, with the result that good mixing of liquid and preparation substance can be achieved. The static mixer 5 according to this embodiment has multi-stage turbulence generation, so that excellent mixing of liquid and preparation substance occurs.

The first and second openings 20, 21 remain sealed by the seal during use. The first, second and third openings 20-22 are formed directly in the parts of the cup 10 concerned during the production process of the cup 10, for example by an injection moulding process or a process using compression moulds. After filling of the cup, the various elements that are important for the flow inside the cup are formed by means of the seal 15 and covering layer 16.

FIG. 2 shows the outflow part of the cup 10 in more detail, together with the seal 15. On the side of the outlet opening 24 the cup 10 is provided with a space 50. For this purpose, the static mixer 5 (as part of the shell 11) is provided with an outside wall 51, and with a conically shaped outer side or outlet part 52 which opens into the outlet opening 24. The conically shaped outlet part 52 has an inverted point shape, which is intended to pierce or perforate the seal 15 from the inside. In the first instance, the seal 15 will be plastically deformed and will stretch, but after that a point-shaped initial opening will be produced in the seal 15. This opening is increasingly enlarged by stretching of the outlet part 52. It can also be so that the initial opening in the seal is pointed-shaped, and after that the seal rolls back further.

The seal 15 in one embodiment comprises a combination of two foils or films, for example laminated foils or films. One layer of the seal 15 comprises a plastic film (polypropylene, for example) on the side of the outlet opening 24, and a second layer comprises an aluminium film. The plastic film comprises a material that is softer than the material of the cup 10 (more particularly that of the shell 11 and static mixer 5). This means that a good seal of the outlet opening 24 (for example, during transport and storage) is achieved in a simple manner.

In one embodiment weakened parts 54 are provided in the seal 15, for example in the form of partial cuts through one or more layers of the seal 15. Furthermore, the seal 15 can be preformed as shown, part of it being flat for sealing the first and second openings 20, 21, and there being a central part extending further inwards into the space 51. This means that the outlet opening 24 is sealed in a more reliable way.

FIG. 2 also shows that the outlet opening 24 is provided with a rough inner surface, for example through the presence of extra grooves 53 around the inner circumference of the outlet opening 24. An enlargement of the circumferential line of the cross-sectional surface of the outlet opening 24 can also be obtained in another way. In both cases this will ensure even better frothing for the prepared product.

FIGS. 3a and 3b show cross-sectional drawings, which illustrate how the outlet opening 24 is cleared during operation. FIG. 3a shows a part of the cup 10, provided with the seal 15 on the underside, and also a counterpressure element 55. The counterpressure element 55 can be part of a holder for the cup 10, or part of the preparation machine. The counterpressure element 55 is provided with an edge 56 which is rounded. The edge 56 can also be shaped differently, but in such a way that it has no sharp parts, so that the seal 15 cannot be damaged by the counterpressure element 55. In order to open the outlet opening 24, the counterpressure element 55 is brought into contact with the foil at the position of the space 50 in the cup 10, for example by placing the cup 10 in a passive holder. By exerting a force upon the cup 10 (which force is countered by the counterpressure element 55), tension is built up in the seal 15. From the inside of the cup 10 the pointed shape of the outlet part 52 will ensure that the seal 15 is stretched and ultimately breaks open, as shown in FIG. 3b. The edge 56 of the counterpressure element 55 is entirely passive during the opening of the seal 15.

If the seal 15 is provided with weakened parts 54 (see FIG. 2), the seal 15 will open along those parts. In a further embodiment these weakened parts 54 are in the form of radially directed machined lines (for example with partial perforations or thinning of the material), so that the seal will open from the centre in a radial direction. This can occur through stretching of the seal, so that the seal 15 remains resting against the pointed outlet part 52, without producing loose flaps.

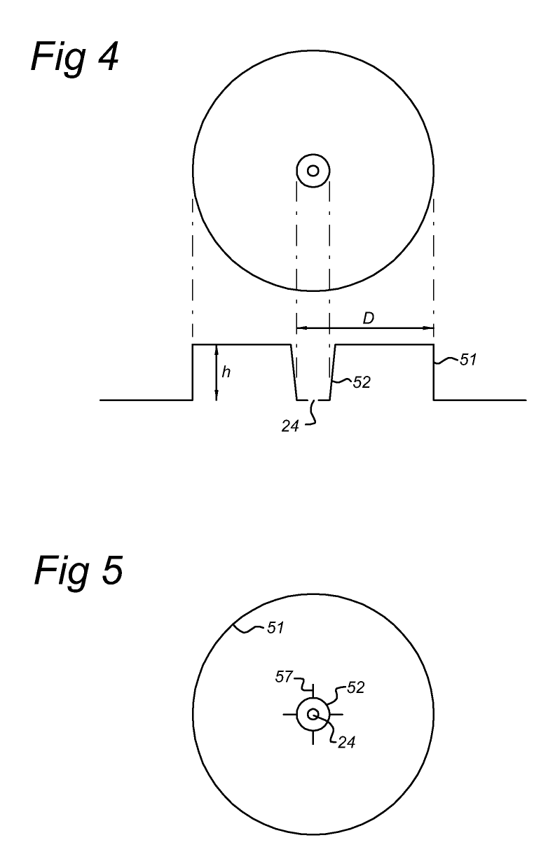

FIG. 4 shows a diagrammatic representation of a bottom view and a cross-sectional view of the outflow part of the cup 10. The distance D indicates a largest measurement from the outside wall 51 to a furthest removed outer edge of the outlet opening 24 (or outlet part 52). Said distance D in the case of the concentrically shaped elements of the cup 10 of the embodiment shown is equal to the radius of the outside wall 51 plus the radius of the outlet part 52 at the position of the outlet opening 24. The depth h of the space 50 is measured along an axis of symmetry of the cup 10. Owing to the fact that the seal 15 is opened by the point-shaped outlet part 52 from the inside of the cup 10, the depth h of the space 50 can be much less than that in known opening mechanisms in the case of which a sealing foil is cut open and folded back. The depth h can be less than half the distance D (h<D/2). Even in that case the outlet opening 24 is fully cleared.

In a further embodiment of the cup 10 one or more cutting elements 57 extending into the space 50 are placed on the outlet part 52. The cutting elements 57 can, for example, be in the form of ribs 57 projecting radially from the outlet opening 24. An example of this is illustrated in the partial bottom view shown in FIG. 5. From the outlet part 52, four cutting elements 57 are provided, extending radially from the outlet part 52 into the space 50. After tension is applied to the seal 15 by placing the cup on the counterpressure element 55, the cutting elements 57 ensure that the seal 15, after an initial opening by the outlet part 52, opens further in the radial direction in a controlled manner from inside the cup 10. Again through the stretching properties of the material of the seal 15, said seal can remain resting against the point-shaped outlet part 52, so that no loose flaps are produced.

The invention is explained in the above description on the basis of a number of embodiments with reference to the appended drawings. However, the scope of protection of this application also extends to possible changes and modifications which fall within the definitions of the terms used in the claims. For example, the shape of the cup is shown as circular, but it will be clear to the person skilled in the art that other shapes (square, inverted pyramid shape, oval) can also be used. Moreover, the embodiments of the outlet part of the cup 10 described can also be used in a cup which is not provided with a static mixer 5.

1. Cup for preparing a liquid product, comprising an outlet opening for discharging the prepared beverage or dish, which outlet opening is sealed with a seal prior to use, and comprising a space around the outlet opening, in which the seal comprises a piercable seal, and the outlet opening has a conically shaped outer side which is equipped so that in operation it works together with a passive counterpressure element to pierce the seal from the inside of the cup in order to clear the outlet opening.

2. Cup according to claim 1, in which the seal is provided with weakened parts.

3. Cup according to claim 2, in which the weakened parts comprise machined lines running in the radial direction from the position where the seal seals the outlet opening prior to use.

4. Cup according to claim 1, in which the space around the outlet opening is bounded by a wall, and the space has a dimension in the direction of an axis of symmetry of the cup which is less than half the distance between the wall and a furthest removed outer side of the outlet opening.

5. Cup according to claim 1, in which the cup in operation works together with a passive counterpressure element which is provided with an edge of such a shape that it cannot perforate the seal.

6. Cup according to claim 1, in which an outer side of the outlet opening is provided with ribs projecting radially from the outlet opening.

7. Cup according to claim 1, in which the seal is a composite foil consisting of a plastic film and an aluminium film.

8. Cup according to claim 7, in which the plastic film comprises a material which is softer than the material of the cup.

9. Cup according to claim 1, in which the outlet opening is provided with a rough inside surface.

10. Cup according to claim 1, in which the outlet opening is provided with an enlarged cross-sectional surface.

11. Counterpressure element for use with a cup according to claim 1, comprising a rounded edge for placing the seal of the cup under tension.

12. Use of a cup according to claim 1 in a preparation machine provided with an accommodation space for accommodation of the cup, the preparation machine being equipped with a passive element which exerts counterpressure during positioning of the cup, so that means which form part of the cup open the seal of the cup, and for conveying a liquid through the cup by way of the perforated covering layer of the cup to the outlet opening.
